(19) United States
(12) Patent Application Publication
(10) Pub. No.: US 2025/0247925 A1
(43) Pub. Date: Jul. 31, 2025

(54) HEATING COOKER

(71) Applicant: SHARP KABUSHIKI KAISHA, Sakai City (JP)

(72) Inventors: Takahiro NAKAMOTO, Sakai City (JP); Hiromi Suenaga, Sakai City (JP); Yoshikazu Kitaguchi, Sakai City (JP); Nobuo Takemoto, Sakai City (JP)

(21) Appl. No.: 19/019,010

(22) Filed: Jan. 13, 2025

(30) Foreign Application Priority Data
Jan. 31, 2024 (JP) 2024-012811

(51) Int. Cl. H05B 6/64; F24C 7/06

(52) U.S. Cl. CPC H05B 6/647; F24C 7/067

(57) ABSTRACT

A microwave grill device includes a first heating unit, a support unit, and an operation unit. On the first heating unit, a first object to be heated is placed, and the first heating unit heats the first object to be heated. The support unit supports the lower side of the first heating unit. The operation unit receives operation information on the first heating unit. The operation unit is provided on one side in a first direction intersecting an up-down direction. The support unit includes a placement portion and a column portion. The first heating unit is placed on the placement portion. The column portion extends downward from the placement portion. The placement portion is provided so as to extend over an entire width of the first heating unit along a second direction intersecting the up-down direction and the first direction.

### CROSS-REFERENCE TO RELATED APPLICATION

The present application claims priority from Japanese Application JP2024-012811, the content to which is hereby incorporated by reference into this application.

### BACKGROUND OF THE DISCLOSURE

### 1. Technical Field

The present disclosure relates to a heating cooker.

### 2. Description of the Related Art

JP 2011-192659 A discloses a heating cooker. The heating cooker disclosed in JP 2011-192659 A includes a heating part, a top plate made of glass, and a light emission display unit. The heating part includes an induction heating coil, a radiant heater, and a roaster. The top plate is provided above the induction heating coil and the radiant heater, and an object to be heated is placed thereon.

### SUMMARY OF THE DISCLOSURE

In the heating cooker of JP 2011-192659 A, the upper unit including the induction heating coil and the radiant heater is fitted and supported from the upper portion with respect to the cooking table, so that it is difficult to move together with the lower unit, and the installation location of the heating cooker is easily limited.

The present disclosure has been made in view of the above problems, and an object of the present disclosure is to provide a heating cooker in which a placement portion for an object to be heated is able to be moved together with a support unit of the placement portion.

A heating cooker according to the present disclosure includes a first heating unit, a support unit, and an operation unit. A first object to be heated is placed on the first heating unit, and the first heating unit is configured to heat the first object to be heated. The support unit is configured to support a lower side of the first heating unit. The operation unit receives operation information on the first heating unit. The operation unit is provided on one side in a first direction intersecting an up-down direction. The support unit includes a placement portion and a column portion. The first heating unit is placed on the placement portion. The column portion extends downward from the placement portion. The placement portion is provided so as to extend over an entire width of the first heating unit along a second direction intersecting the up-down direction and the first direction.

According to the present disclosure, the placement portion for the object to be heated can be moved together with the support unit of the placement portion.

### BRIEF DESCRIPTION OF THE DRAWINGS

FIG. 1 is a view illustrating a microwave grill device according to the present embodiment;

FIG. 2 is a view illustrating the microwave grill device according to the present embodiment;

FIG. 3 is a side view of the microwave grill device as viewed from a right side;

FIG. 4 is a side view of the microwave grill device from which a right panel and a left panel are removed, as viewed from the right side;

FIG. 5 is a view illustrating a positional relationship among a first heating unit, an operation unit, and a support unit;

FIG. 6 is an exploded perspective view illustrating the positional relationship among the first heating unit, the operation unit, and the support unit;

FIG. 7 is a view illustrating the microwave grill device as viewed from a front and obliquely upper side;

FIG. 8 is a view illustrating a rear side of the operation unit;

FIG. 9 is an exploded perspective view of the operation unit;

FIG. 10 is an exploded perspective view of the operation unit at another angle;

FIG. 11 is an enlarged view of an air supply chamber; and

FIG. 12 is an enlarged view of the air supply chamber.

### DETAILED DESCRIPTION

Hereinafter, embodiments of the present disclosure will be described with reference to the drawings. Note that, in the drawings, the same or corresponding portions are denoted by the same reference numerals, and descriptions thereof will not be repeated.

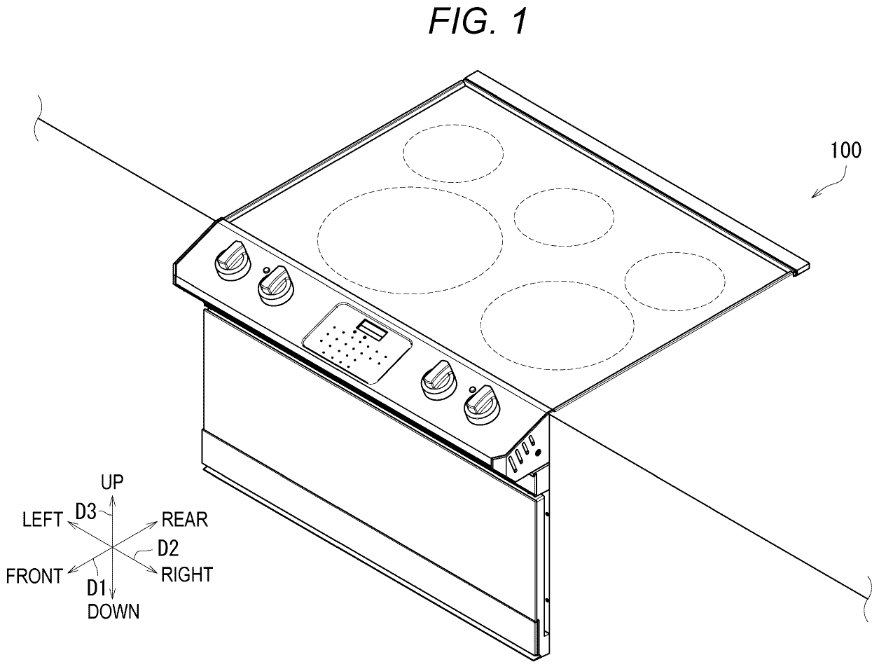

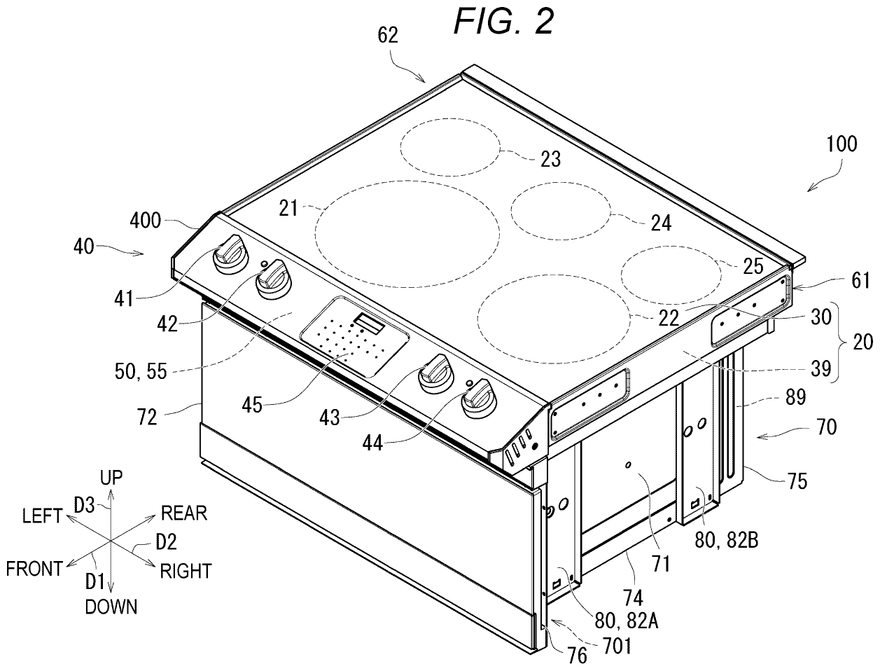

A microwave grill device 100 according to the present embodiment will be described with reference to FIGS. 1 and 2. FIGS. 1 and 2 are views illustrating the microwave grill device 100 according to the present embodiment. The microwave grill device 100 is an example of the “heating cooker”. Note that FIG. 1 illustrates an appearance of the microwave grill device 100 disposed in a kitchen as viewed from an obliquely front right and upper side. FIG. 2 illustrates an external appearance of only microwave grill device 100 as viewed from an obliquely front right and upper side.

The microwave grill device 100 has a box shape. The microwave grill device 100 is disposed, for example, in a kitchen. The microwave grill device 100 heats and cooks a first object to be heated H1. The first object to be heated H1 is, for example, a pot containing food. Specifically, the first object to be heated H1 is placed on the upper surface of the microwave grill device 100, and is subjected to grill heating cooking. In addition, the microwave grill device 100 heats and cooks a second object to be heated H2. The second object to be heated H2 is, for example, a dish on which food is placed. Specifically, the second object to be heated H2 is housed in the microwave grill device 100 and is heated and cooked with microwaves.

The microwave grill device 100 includes a first heating unit 20, a microwave heating/cooking chamber 70, a microwave supply unit 89, an operation unit 40, a support unit 80, a control unit 50, and a storage unit 55. The microwave supply unit 89 is an example of the second heating unit.

In the present embodiment, the side of the microwave grill device 100 on which the operation unit 40 is disposed is defined as the front side of the microwave grill device 100, and the opposite side thereto is defined as the rear side of the microwave grill device 100. In addition, the right side of the microwave grill device 100 as viewed from the front side is defined as the right side of the microwave grill device 100, and the opposite side thereto is defined as the left side of the microwave grill device 100. Note that, these directions and sides are not intended to limit directions and sides when the microwave grill device 100 of the present disclosure is used. Hereinafter, the front-rear direction of the microwave grill device 100 is also referred to as a first direction D1, the left-right direction of the microwave grill device 100 is also referred to as a second direction D2, and the up-down direction of the microwave grill device 100 is also referred to as a third direction D3. The first direction D1, the second direction D2, and the third direction D3 are orthogonal to each other.

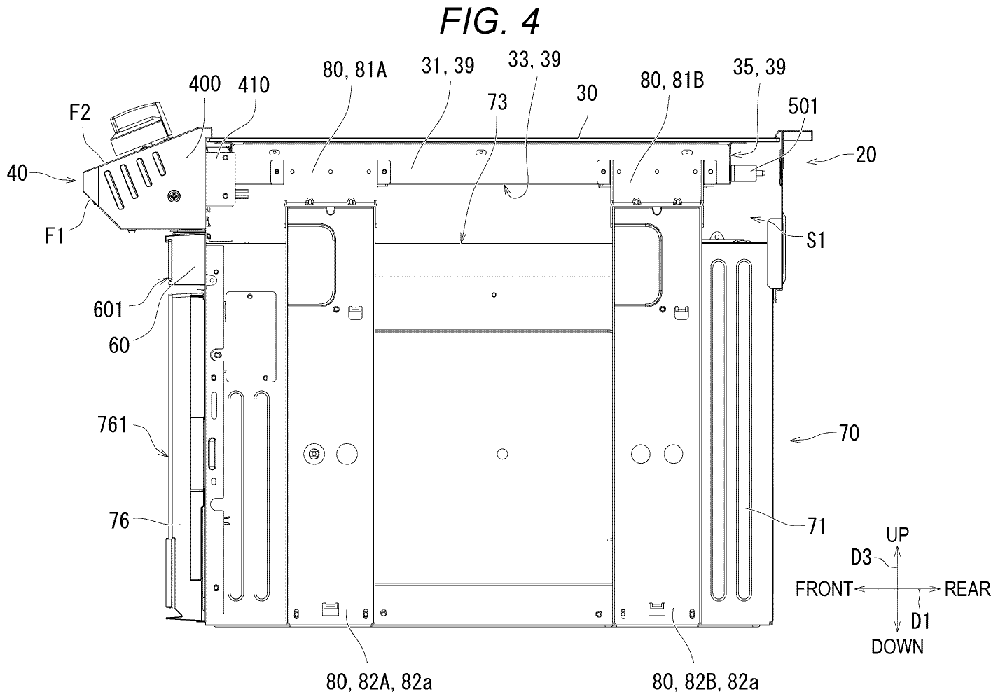

The microwave heating/cooking chamber 70 has a box shape. Specifically, the microwave heating/cooking chamber 70 has a right wall 71, a left wall 72, an upper wall 73 (FIG. 4), a lower wall 74, a rear wall 75, and a front door 76. The microwave heating/cooking chamber 70 is an example of the heating chamber. Specifically, the microwave heating/cooking chamber 70 includes a heating chamber therein.

The front door 76 is a substantially rectangular plate-shaped member. The front door 76 can open and close a front opening 701 of the microwave heating/cooking chamber 70. Specifically, the front door 76 moves between a closed position and an open position. The open position indicates a position where front door 76 opens the opening 701. On the other hand, the closed position indicates a position where the front door 76 covers the opening 701. Typically, the open position indicates a position where the front door 76 is drawn forward with respect to the microwave heating/cooking chamber 70.

When the front door 76 opens the opening 701, the second object to be heated H2 can move into and out of the microwave heating/cooking chamber 70. On the other hand, in a state where the front door 76 covers the opening 701, the second object to be heated H2 is housed inside the microwave heating/cooking chamber 70.

The microwave supply unit 89 supplies microwaves into the microwave heating/cooking chamber 70. Specifically, the microwave supply unit 89 includes a radiation chamber, a magnetron, a waveguide, a rotating antenna, and an antenna motor. The magnetron generates microwaves. The waveguide propagates microwaves generated by the magnetron to the radiation chamber. The rotating antenna is housed in the radiation chamber. The antenna motor drives the rotating antenna. The rotating antenna stirs microwaves and supplies the microwaves into the microwave heating/cooking chamber 70.

The first heating unit 20 heats and cooks the first object to be heated H1. The first heating unit 20 includes a plate 30, a grill chamber 39, a plurality of radiant heaters, a right panel 61, a left panel 62, and a front frame 63. Specifically, the first heating unit 20 includes a first radiant heater 21, a second radiant heater 22, a third radiant heater 23, a fourth radiant heater 24, and a fifth radiant heater 25. Each of the first radiant heater 21, the second radiant heater 22, the third radiant heater 23, the fourth radiant heater 24, and the fifth radiant heater 25 generates heat by applying a direct current to a nichrome wire. Each of the first radiant heater 21, the second radiant heater 22, the third radiant heater 23, the fourth radiant heater 24, and the fifth radiant heater 25 has an annular shape.

The first radiant heater 21 and the second radiant heater 22 are disposed on the front side of the third radiant heater 23, the fourth radiant heater 24, and the fifth radiant heater 25. The second radiant heater 22 is disposed on the right side of the first radiant heater 21. The fourth radiant heater 24 is disposed on the right side of the third radiant heater 23. The fifth radiant heater 25 is disposed on the right side of the fourth radiant heater 24. In the present embodiment, the first radiant heater 21 and the second radiant heater 22 are examples of the first heating device. The third radiant heater 23, the fourth radiant heater 24, and the fifth radiant heater 25 are examples of the second heating device.

The grill chamber 39 includes a right wall 31 (FIG. 4), a left wall 32, a lower wall 33 (FIG. 4), a front wall 34, and a rear wall 35 (FIG. 4). The grill chamber 39 is provided above the microwave heating/cooking chamber 70. In the grill chamber 39, the first radiant heater 21 and the second radiant heater 22 house the third radiant heater 23, the fourth radiant heater 24, and the fifth radiant heater 25. In the present embodiment, the right panel 61 covers the right wall 31. The left panel 62 covers the left wall 32. Specifically, the right panel 61 includes a first panel 61A and a second panel 61B. The first panel 61A covers the right wall 31 of the grill chamber 39. The second panel 61B is disposed below the first panel 61A. Note that the first panel 61A and the second panel 61B may be integrally formed. In addition, the left panel 62 is also similar to the right panel 61.

The plate 30 is a substantially rectangular plate-shaped member. The material of the plate 30 is, for example, glass. The plate 30 is provided above the first radiant heater 21, the second radiant heater 22, the third radiant heater 23, the fourth radiant heater 24, and the fifth radiant heater 25, and covers the upper side of the first radiant heater 21, the second radiant heater 22, the third radiant heater 23, the fourth radiant heater 24, and the fifth radiant heater 25. The first object to be heated H1 is placed on the plate 30.

The support unit 80 supports the lower side of the first heating unit 20. Specifically, the support unit 80 supports a plurality of radiant heaters. Details of the support unit 80 will be described later.

Operation information is input to the operation unit 40. The operation information includes, for example, information for turning on/off the power of the radiant heater, adjusting the output of the radiant heater, turning on/off the power of the microwave supply unit 89, and adjusting the output of the microwave supply unit 89. The operation unit 40 is disposed in front of the grill chamber 39. The operation unit 40 is disposed in front of the plate 30. Further, the operation unit 40 is disposed above the front door 76. In other words, the operation unit 40 is provided in front of the plate 30 and in front of the front end of the front opening 701 of the microwave heating/cooking chamber 70.

Therefore, the plate 30 can have a larger area than in a case where the operation unit 40 is provided behind the microwave heating/cooking chamber 70.

The operation unit 40 includes an operation housing 400, a first dial 41, a second dial 42, a third dial 43, a fourth dial 44, and an operation panel 45. Specifically, the first dial 41 receives the operation information of the first radiant heater 21 by being operated by a cook. In addition, the second dial 42 receives the operation information of the third radiant heater 23 by being operated by the cook. Then, the third dial 43 receives the operation information of the second radiant heater 22 by being operated by the cook. Further, the fourth dial 44 receives the operation information of the fifth radiant heater 25 by being operated by the cook.

The operation panel 45 receives the operation information of the radiant heater or the microwave supply unit 89 by being operated by the cook. Specifically, the operation panel 45 includes various keys and a display device. The display device displays information regarding the first heating unit 20 and the microwave supply unit 89. For example, the display device displays the heating temperature of the first heating unit 20, the heating power of the first heating unit 20, and the like. The display device includes a liquid crystal panel. The operation panel 45 is an example of the display unit.

The first dial 41, the second dial 42, the third dial 43, the fourth dial 44, and the operation panel 45 are disposed in the operation housing 400. The operation housing 400 is provided to protrude with respect to the front end of the front door 76. Details of the operation housing 400 will be described later.

The storage unit 55 (FIG. 2) includes a random access memory (RAM) and a read only memory (ROM). The storage unit 55 stores a control program for controlling the operation of each unit of the microwave grill device 100.

The control unit 50 (FIG. 2) is a hardware circuit including a processor such as a central processing unit (CPU). The control unit 50 executes the control program stored in the storage unit 55. Accordingly, the control unit 50 controls the first heating unit 20 and the microwave supply unit 89. For example, the control unit 50 outputs drive information to the first heating unit 20 on the basis of the operation information. For example, the control unit 50 repeats turning on the power supply of the first radiant heater 21 for a first predetermined period and turning off the power supply for a second predetermined period. In addition, specifically, when the operation information is input to the operation panel 45 by the cook, the control unit 50 controls the microwave supply unit on the basis of the operation information. For example, the control unit 50 turns on the power supply of the microwave supply unit 89 for a third predetermined period.

Note that the drive information may further include a drive state of each of the plurality of radiant heaters and a drive state of the microwave supply unit 89. Then, the drive information may further include the number of times of driving the radiant heater or ON/OFF of the power supply of the radiant heater.

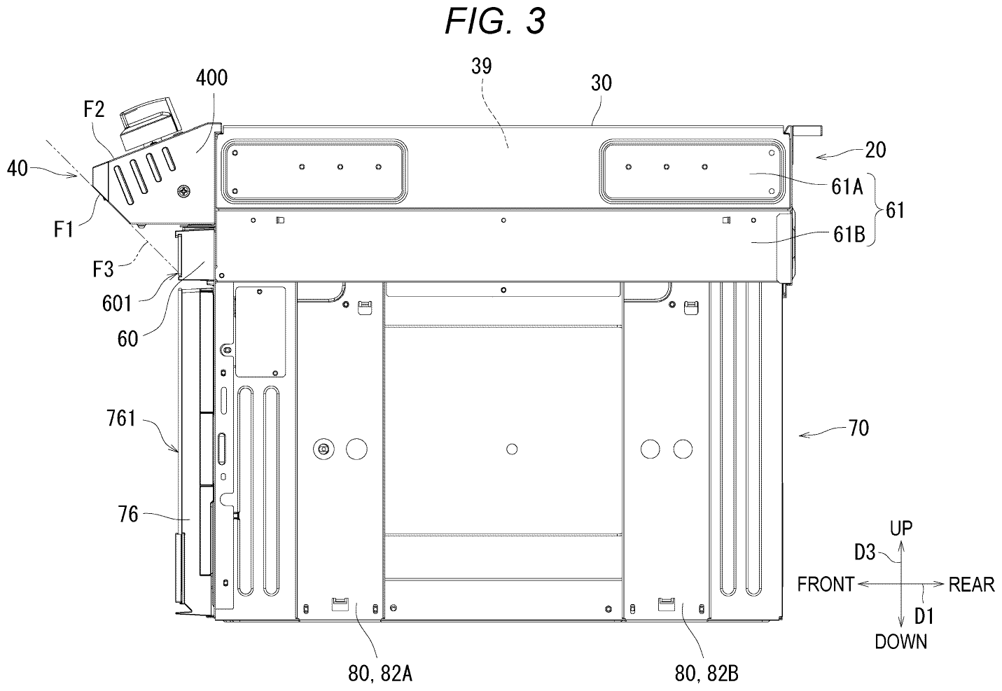

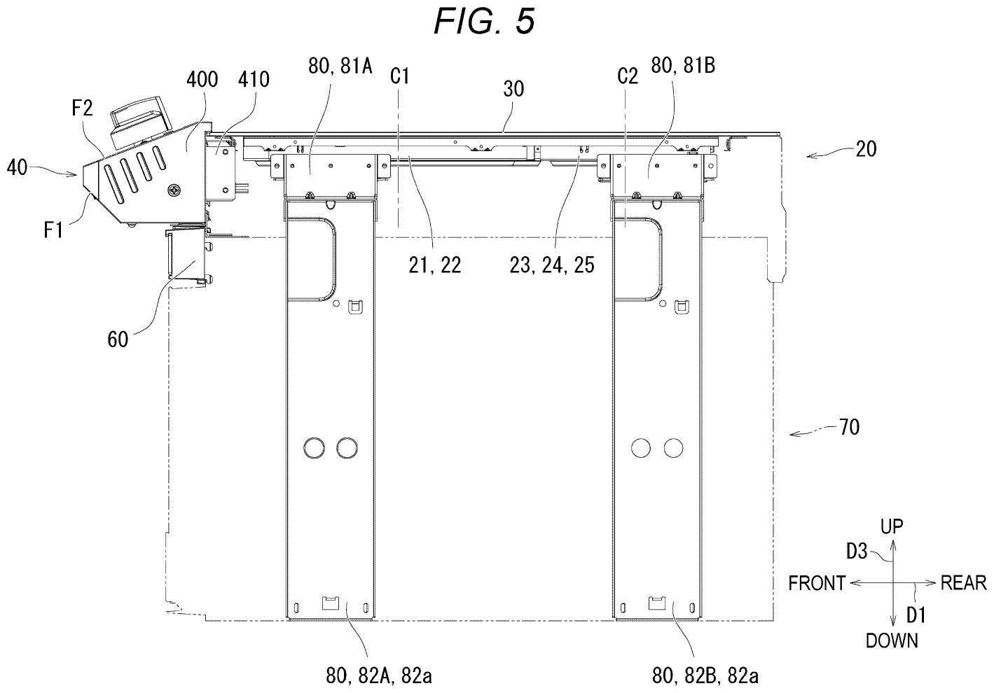

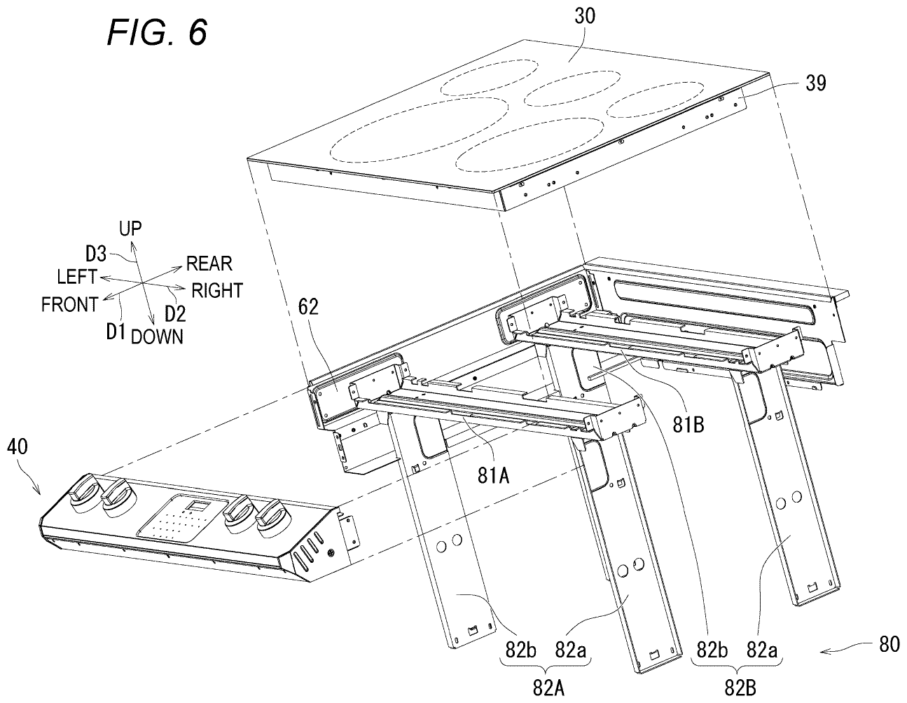

Next, the support unit 80 will be described with reference to FIGS. 1 to 4. FIG. 3 is a side view of the microwave grill device 100 as viewed from a right side. FIG. 4 is a side view of the microwave grill device 100 from which the right panel 61 and the left panel 62 are removed, as viewed from the right side. FIG. 5 is a view illustrating a positional relationship among the first heating unit 20, the operation unit 40, and the support unit 80. FIG. 6 is an exploded perspective view illustrating the positional relationship among the first heating unit 20, the operation unit 40, and the support unit 80.

As illustrated in FIGS. 3 to 6, the support unit 80 includes placement portions 81A and 81B and column portions 82A and 82B. The first heating unit 20 is placed on the placement portion 81A and the placement portion 81B. The column portions 82A and 82B extend downward from the placement portion 81A and the placement portion 81B, respectively.

Specifically, the placement portion 81A and the placement portion 81B are provided below the lower wall 33 so as to be in contact with the lower wall 33. The placement portion 81A and the placement portion 81B are provided so as to extend over the entire width of the first heating unit 20 along the left-right direction (second direction D2).

In the present embodiment, the width of the placement portion 81A and the placement portion 81B in the front-rear direction (first direction D1) is shorter than the width of the first heating unit 20 (plate 30) in the front-rear direction (first direction D1). That is, the width of the placement portion 81A and the placement portion 81B in the front-rear direction (first direction D1) occupies only a part of the width of the first heating unit 20 (plate 30) in the front-rear direction (first direction D1). In this manner, the first heating unit 20 can be supported with a simple configuration. In addition, the first heating unit 20 and the support unit 80 can be moved together, and the microwave grill device 100 can be installed at a wider range of locations.

As illustrated in FIG. 4, the placement portion 81A extends below the first radiant heater 21 and the second radiant heater 22 (first heating device) in the left-right direction (second direction D2). The placement portion 81A is an example of the first placement portion. The placement portion 81B extends below the third radiant heater 23, the fourth radiant heater 24, and the fifth radiant heater 25 (second heating device) in the left-right direction (second direction D2). The placement portion 81B is an example of the second placement portion. In this manner, the placement portion 81A and the placement portion 81B are positioned apart from each other in the front-rear direction (first direction D1). Therefore, the placement portion 81A and the placement portion 81B can support the first heating unit 20 while balancing the weight in the front-rear direction (first direction D1).

More specifically, the placement portion 81A is provided at a position not including a position C1 indicating the center of the first radiant heater 21 and the center of the second radiant heater 22 in the front-rear direction (first direction D1). Specifically, the placement portion 81A is provided on the front side of the position C1. The placement portion 81B is provided at a position including a position C2 indicating the center of the third radiant heater 23, the center of the fourth radiant heater 24, and the center of the fifth radiant heater 25 in the front-rear direction (first direction D1). Specifically, the placement portion 81B is provided over the front side of the third radiant heater 23, the fourth radiant heater 24, and the fifth radiant heater 25 including the position C2 in the front-rear direction (first direction D1) and the rear side of the third radiant heater 23, the fourth radiant heater 24, and the fifth radiant heater 25. That is, the placement portion 81B passes below the position C2. In addition, the placement portion 81B is provided to support the rear side of the second heating device.

Therefore, the placement portion 81A and the placement portion 81B can support the first heating unit 20 while balancing the weights of the first heating device, the second heating device, and the operation unit 40 in the front-rear direction (first direction D1).

As illustrated in FIGS. 4 and 6, the column portion 82A includes a pair of columns 82a and 82b. The pair of columns 82a and 82b of the column portion 82A face each other in the left-right direction (second direction D2). The column portion 82B includes a pair of columns 82a and columns 82b. The pair of columns 82a and 82b of the column portion 82B face each other in the left-right direction (second direction D2). The widths of the column portion 82A and the column portion 82B in the front-rear direction (first direction D1) are the same as the widths of the placement portion 81A and the placement portion 81B in the front-rear direction (first direction D1), respectively.

The microwave heating/cooking chamber 70 is disposed between the column 82a and the column 82b of the column portion 82A and between the column 82a and the column 82b of the column portion 82B. The column 82a of the column portions 82A is connected to the right wall 71 of the microwave heating/cooking chamber 70. The column 82a of the column portion 82B is connected to the right wall 71 of the microwave heating/cooking chamber 70. The column 82b of the column portion 82A is connected to the left wall 72 of the microwave heating/cooking chamber 70. The column 82b of the column portion 82B is connected to the left wall 72 of the microwave heating/cooking chamber 70.

For example, the column portion 82A and the column portion 82B are directly attached to the microwave heating/cooking chamber 70. Accordingly, the first heating unit 20 can be disposed above the microwave heating/cooking chamber 70 with a small number of components.

In the present embodiment, the placement portion 81A and the placement portion 81B have the same shape. In addition, the column portion 82A and the column portion 82B have the same shape. Specifically, the column 82a of the column portion 82A and the column 82a of the column portion 82B have the same shape. The column 82b of the column portion 82A and the column 82b of the column portion 82B have the same shape. Further, the pair of columns 82a and 82b have the same shape. That is, the column 82a of the column portion 82A, the column 82a of the column portion 82B, the column 82b of the column portion 82A, and the column 82b of the column portion 82B have the same shape. Therefore, a plurality of the same components can be easily manufactured, and manufacturing cost can be reduced.

Note that in the present embodiment, the number and combination of the placement portions and the column portions provided in the microwave grill device 100 are not particularly limited. For example, two placement portions and a pair of column portions may be provided, or two or more pairs of column portions may be provided for one placement portion. In addition, the widths of the placement portion and the column portion in the front-rear direction (first direction D1) may be different from each other. Further, the widths of the placement portion and the column portion in the front-rear direction (first direction D1) may occupy the entire width of the first heating unit 20 (plate 30) in the front-rear direction (first direction D1).

Next, a panel member 60 provided in the microwave grill device 100 will be described with reference to FIGS. 3 to 5.

In the present embodiment, the lengths of the column portion 82A and the column portion 82B in the up-down direction (third direction D3) are larger than the lengths of the microwave heating/cooking chamber 70 in the up-down direction (third direction D3). As a result, as illustrated in FIG. 4, a space S1 is formed between the upper wall 73 of the microwave heating/cooking chamber 70 and the lower wall 33 of the grill chamber 39 and between the upper wall 73 of the microwave heating/cooking chamber 70 and the placement portions 81A and 81B.

In the microwave grill device 100, the panel member 60 is provided so as to close at least a part of the front side of the space S1. Specifically, in the microwave grill device 100, the operation housing 400 and the front door 76 are positioned apart from each other in the up-down direction (third direction D3). The panel member 60 is provided between the operation housing 400 and the front door 76. The panel member 60 is a substantially rectangular plate-shaped member. Typically, the panel member 60 is attached above the opening 701 in the microwave heating/cooking chamber 70. The operation housing 400 and the panel member 60 are provided so as to close the front side of the space S1.

The heat generated from the first heating unit 20 by heating by the first heating unit 20 and the heat generated from the microwave heating/cooking chamber 70 by heating by the microwave supply unit 89 are transferred to the space S1. As a result, the space S1 tends to have a high temperature. Therefore, by providing the panel member 60, it is possible to block the high-temperature air in the space S1 from moving to the front side. As a result, heat is less likely to be transferred to the cook positioned in front of the operation unit 40, and the cook can comfortably operate the operation unit 40.

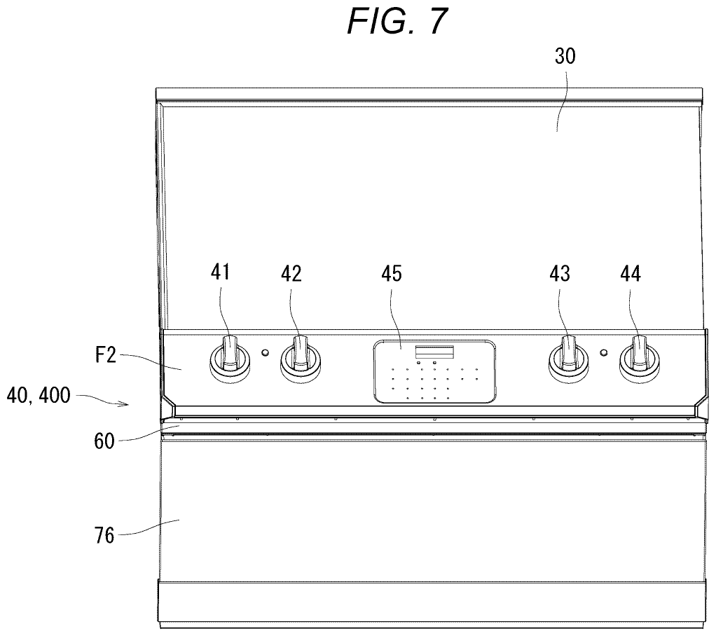

Next, the appearance of the microwave grill device 100 from a front and obliquely upper view will be described with reference to FIGS. 3 to 5 and 7. FIG. 7 is a view illustrating the microwave grill device 100 as viewed from a front and obliquely upper side.

As illustrated in FIG. 3, the operation housing 400 has a first inclined surface F1 inclined upward from the lower surface of the operation housing 400 toward the front side. By providing the first inclined surface F1, for example, when the cook looks down on the operation panel 45 from an obliquely upper front view, the panel member 60 becomes easily noticeable.

Typically, an end 761 of the front door 76 on the front side is positioned on the front side of a virtual plane F3 obtained by extending the first inclined surface F1. Therefore, when the cook looks down on the operation panel 45 from the obliquely upper front view, the front door 76 becomes easily noticeable in addition to the panel member 60.

Further, in the microwave grill device 100, the front end 761 of the front door 76 and the front end 601 of the panel member 60 are aligned in the front-rear direction (first direction D1). Accordingly, it is possible to give a visual sense of unity to the panel member 60 and the front door 76 while suppressing a decrease in visibility between the panel member 60 and the front door 76.

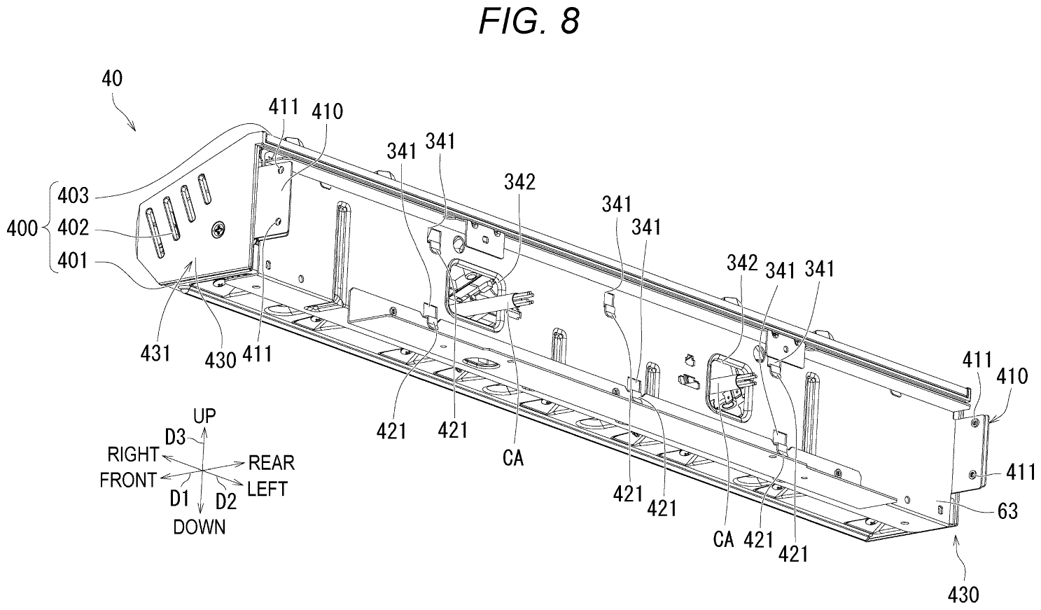

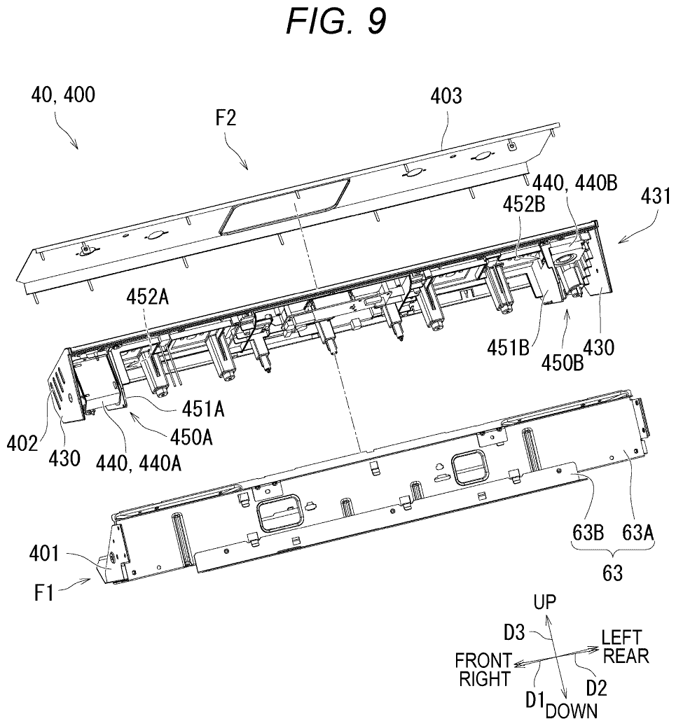

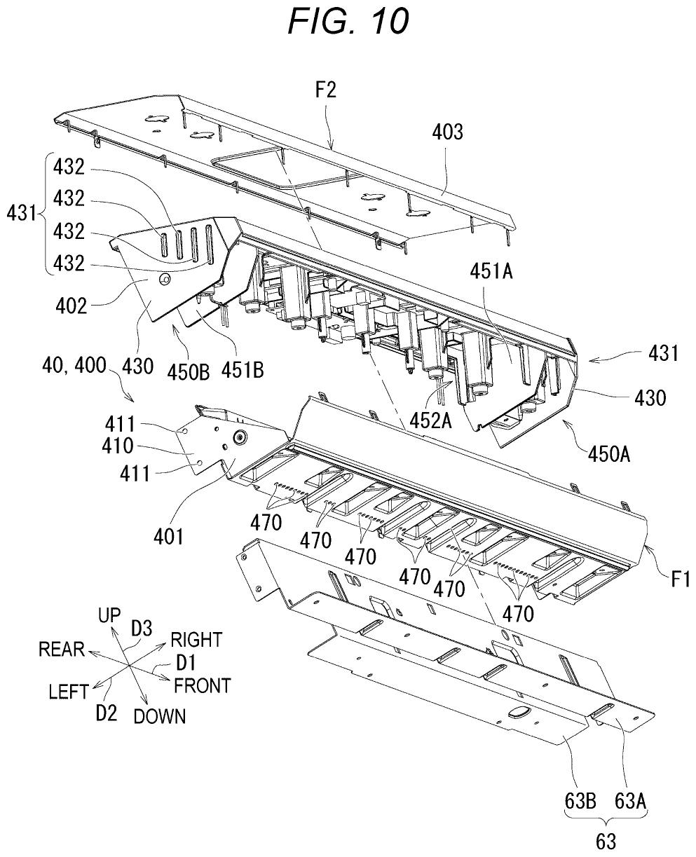

Next, details of the operation unit 40 will be described with reference to FIGS. 3 to 5 and FIGS. 8 to 10. FIG. 8 is a view illustrating a rear side of the operation unit 40. FIG. 9 is an exploded perspective view of the operation unit 40. FIG. 10 is an exploded perspective view of the operation unit 40 at another angle. Note that FIGS. 8 to 10 illustrate the front frame 63 in addition to the operation unit 40.

As illustrated in FIGS. 8 to 10, the operation housing 400 includes a base portion 401, a housing portion 402, and a cover portion 403. The base portion 401 constitutes a bottom of the operation housing 400. The lower surface and the first inclined surface F1 are formed on the base portion 401. For example, the base portion 401 is made of resin.

The housing portion 402 is disposed above the base portion 401. The first dial 41, the second dial 42, the third dial 43, the fourth dial 44, and the operation panel 45 are disposed in the housing portion 402. Specifically, the first dial 41, the second dial 42, the third dial 43, the fourth dial 44, and the display device (display surface) of the operation panel 45 are disposed to be exposed from the housing portion 402. In the operation housing 400, in a space surrounded by the housing portion 402 and the base portion 401, components other than the display device (display surface) of the operation panel 45 are housed. For example, the housing portion 402 is made of resin.

The housing portion 402 has a second inclined surface F2. As illustrated in FIGS. 3 to 5, the second inclined surface F2 is inclined with respect to the plate 30 of the first heating unit 20 in the up-down direction (third direction D3). Specifically, the second inclined surface F2 is inclined obliquely downward on the front side. The display device of the operation panel 45 is disposed on the second inclined surface F2. Accordingly, in a case where the length in the front-rear direction (first direction D1) is the same as that of the operation housing 400, the length of the display device in a longitudinal direction can be increased as compared with a case where the display device of the operation panel 45 is disposed on a horizontal plane. Therefore, the display area of the operation panel 45 can be increased.

The cover portion 403 covers the housing portion 402 and forms the second inclined surface F2. For example, the cover portion 403 is made of metal.

Next, attachment of the operation housing 400 will be described with reference to FIGS. 4, 5, 8, and 10.

As illustrated in FIGS. 4, 5, 8, and 10, the operation housing 400 has a pair of connection portions 410. The pair of connection portions 410 is connected to the first heating unit 20. Specifically, the pair of connection portions 410 is provided at both ends of the base portion 401 in the left-right direction (second direction D2) in the operation housing 400. Each of the pair of connection portions 410 is provided so as to protrude toward the rear side of the operation housing 400. The pair of connection portions 410 is attached to the front frame 63. Specifically, the front frame 63 includes a first support member 63A and a second support member 63B. The first support member 63A is in contact with the rear surface and the lower surface of the base portion 401. In addition, the first support member 63A has a shape extending along the pair of connection portions 410. The second support member 63B is disposed on the rear side of the first support member 63A.

Accordingly, the operation housing 400 is supported with respect to the first heating unit 20 at both ends in the left-right direction (second direction D2). Thus, the operation housing 400 can be stably supported as compared with a case where only the lower surface of the operation housing 400 is supported.

Specifically, each of the pair of connection portions 410 has a shape extending in the up-down direction (third direction D3). Typically, each of the pair of connection portions 410 is a substantially rectangular plate-shaped member. The connection portion 410 has at least two attachment portions 411 attached to the first heating unit 20. For example, the connection portion 410 is screwed to the first support member 63A. That is, a through hole through which a screw passes is provided as the attachment portion 411 in the connection portion 410. The two attachment portions 411 are disposed side by side in the up-down direction (third direction D3). Accordingly, the connection portion 410 is supported by the first heating unit 20 at least at two points arranged in the up-down direction (third direction D3). As a result, the operation housing 400 is less likely to rotate in the up-down direction (third direction D3), and the posture of the operation unit is likely to be stabilized.

As illustrated in FIGS. 8 and 9, the operation housing 400 includes a hook 421 which is hooked on the first support member 63A and the second support member 63B positioned on the front side of the first heating unit 20. Specifically, one or more through holes 341 are provided in the first support member 63A. The hook 421 corresponding to the through hole 341 is provided on the rear surface of the operation housing 400. In the present embodiment, the hook 421 is provided in the base portion 401, but may be provided in the housing portion 402 or the cover portion 403. The hook 420 has a shape that curves convexly upward. The hook 421 is hooked on an edge of the through hole 341. Note that the hook 421 may be hooked on the second support member 63B together with the edge of the through hole 341.

The hook 421 makes it difficult for the operation housing 400 to move with respect to the front wall 34 in the front-rear direction (first direction D1), and the posture of the operation unit is easily stabilized.

As illustrated in FIGS. 8 to 10, the operation housing 400 has a side wall portion 430. Typically, the side wall portions 430 are provided at both ends of the housing portion 402 in the left-right direction (second direction D2) in the operation housing 400. The side wall portion 430 has a vent hole 431. The vent hole 431 is formed by, for example, a plurality of slits 432 penetrating the side wall portion 430. Note that the vent hole 431 may be one through hole penetrating the side wall portion 430. The vent hole 431 is an example of the first vent hole. The size, shape, and number of the slits 432 are not particularly limited.

By providing the vent hole 431 in the operation housing 400, the air permeability of the operation housing 400 is improved. As a result, a rise in temperature of the operation housing 400 due to the heating of the first heating unit 20 or the heating of the microwave supply unit 89 can be suppressed. Note that the vent hole 431 is not limited to the side wall portion 430, and may be provided on any surface of the operation housing 400. For example, the vent hole 431 may be provided on the lower surface of the operation housing 400.

As illustrated in FIG. 9, the operation housing 400 includes a blower fan 440 that supplies air to the operation housing 400. In the present embodiment, the operation housing 400 includes two blower fans 440A and 440B. By providing the blower fan 440 in the operation housing 400, it is possible to efficiently exchange the air inside the operation housing 400 and improve the heat dissipation of the operation housing 400. Typically, the blower fans 440A and 440B are controlled by the control unit 50.

The operation housing 400 has an air supply chamber 450 connected to the vent hole 431. In the present embodiment, the operation housing 400 includes two air supply chambers 450A and 450B. The air supply chamber 450A is connected to the vent hole 431 provided in the right side wall portion 430 of the operation housing 400. The air supply chamber 450B is connected to the vent hole 431 provided in the left side wall portion 430 of the operation housing 400. That is, the air supply chamber 450A is provided on the right side of the operation housing 400. The air supply chamber 450B is provided on the left side of the operation housing 400.

Specifically, the operation housing 400 has a partition portion 451A facing the right side wall portion 430 and a partition portion 451B facing the left side wall portion 430. The partition portion 451A and the partition portion 451B are provided in the housing portion 402. The partition portion 451A is positioned on the left side of the right side wall portion 430. The partition portion 451B is positioned on the right side of the left side wall portion 430. Therefore, the air supply chamber 450A is formed between the right side wall portion 430 and the partition portion 451A. The air supply chamber 450B is formed between the left side wall portion 430 and the partition portion 451B.

The air supply chamber 450A has a vent hole 452A different from the vent hole 431. The air supply chamber 450B has a vent hole 452B different from the vent hole 431. In addition, the blower fan 440A is disposed in the air supply chamber 450A. The blower fan 440B is disposed in the air supply chamber 450B. When the blower fan 440A or 440B is driven, air is supplied from the vent holes 431 to the air supply chamber 450A or the air supply chamber 450B, and the air in the air supply chamber 450A or the air supply chamber 450B is exhausted from the air supply chamber 450A or the air supply chamber 450B through the vent hole 452A or the vent hole 452B, respectively. In this manner, air can be efficiently supplied into the operation housing 400. The vent holes 452A and 452B are an example of the second vent hole.

For example, the vent hole 452A is provided in the partition portion 451A. The vent hole 452B is provided in the partition portion 451B. That is, the vent hole 452A faces the right vent hole 431 in the left-right direction (second direction D2). The vent hole 452B faces the left vent hole 431 in the left-right direction (second direction D2). Therefore, an air passage from the right vent hole 431 to the vent hole 452A and an air passage from the left vent hole 431 to the vent hole 452B become linear, and air easily passes through the air supply chamber 450A or the air supply chamber 450B.

In the present embodiment, the vent hole 431 is provided on the front side of the vent hole 452A and the vent hole 452B. Specifically, the vent hole 431 is disposed on the front side in the front-rear direction (first direction D1) in the side wall portion 430. The vent hole 452A and the vent hole 452B are disposed on the rear side in the front-rear direction (first direction D1). In this manner, by providing the vent holes 431 at positions farther from the heat sources of the first heating unit 20 and the microwave supply unit 89 than the vent hole 452A and the vent hole 452B, colder air is easily supplied into the operation housing 400.

The operation housing 400 has a plurality of vent holes 470 on the lower surface. Air having passed through the air supply chamber 450A or the air supply chamber 450B is exhausted from the vent hole 470 to the outside of the operation housing 400. The vent hole 470 is an example of the third vent hole. For example, the vent hole 470 is positioned behind the front end 601 of the panel member 60. Therefore, the air exhausted from the vent hole 470 is less likely to directly hit the cook.

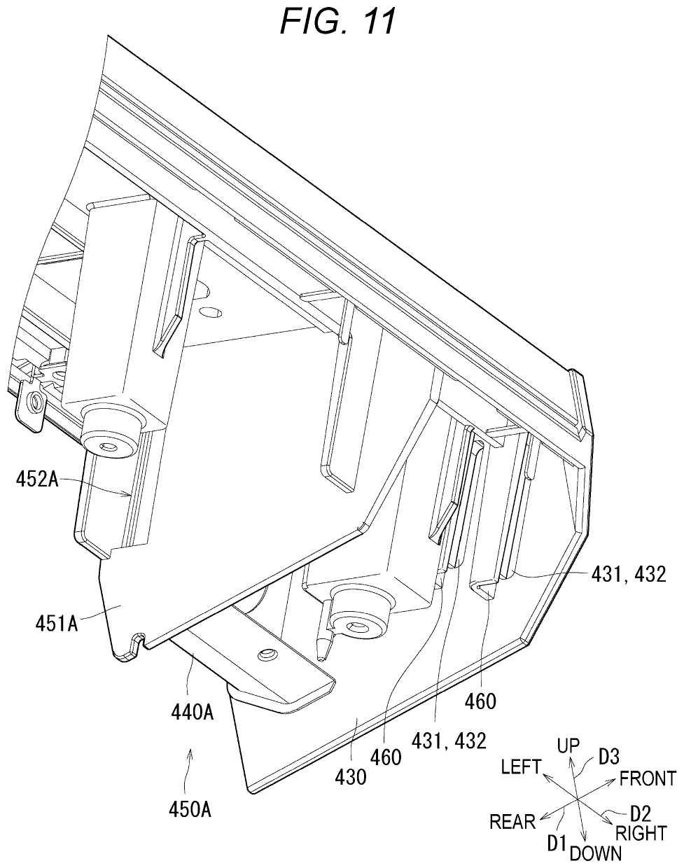

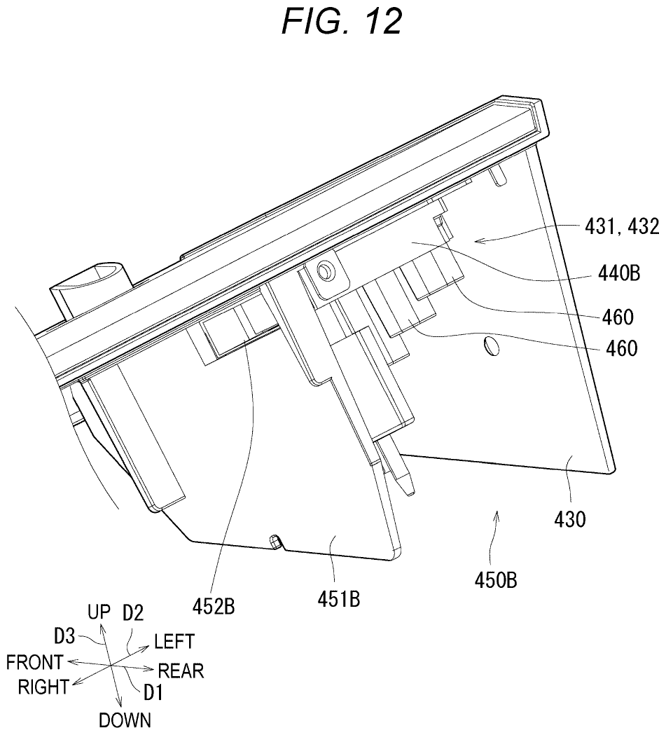

Next, the air supply chamber 450A and the air supply chamber 450B will be described with reference to FIGS. 8 to 12. FIG. 11 is an enlarged view of the air supply chamber 450A. FIG. 12 is an enlarged view of the air supply chamber 450B.

As illustrated in FIGS. 8 to 12, the direction of the blower fan 440A disposed in the air supply chamber 450A is different from the direction of the blower fan 440B disposed in the air supply chamber 450B. Accordingly, air blowing by the blower fan 440A and air blowing by the blower fan 440B are generated at different positions inside the operation housing 400. Therefore, air can easily pass through a wider range inside the operation housing 400.

For example, the blower fan 440A is disposed along the front-rear direction (first direction D1). The blower fan 440B is disposed along a direction intersecting the front-rear direction (first direction D1). Typically, the blower fan 440B is disposed along the up-down direction (third direction D3). Specifically, the blower fan 440B is a centrifugal fan (sirocco fan). The rotation shaft of the blower fan 440A and the rotation shaft of the blower fan 440B are disposed to extend along the front-rear direction (first direction D1) and the up-down direction (third direction D3), respectively.

The vent hole 452A of the air supply chamber 450A has a shape extending in the up-down direction (third direction D3). The vent hole 452B of the air supply chamber 450B has a shape extending in the front-rear direction (first direction D1). By making the shape of the vent hole 452A and the shape of the vent hole 452B correspond to the direction of the blower fan 440A and the direction of the blower fan 440B, respectively, air can be efficiently supplied into the operation housing 400.

For example, the vent hole 452A is provided on the first heating unit 20 side (rear side) of the operation housing 400. The vent hole 452B is provided on the second inclined surface F2 side. Accordingly, it is possible to suppress a rise in the temperatures of the front side of the plate 30 which tends to be hot and the second inclined surface F2 which is the operation surface of the operation unit.

The vent hole 431 includes a partition wall 460 which separates each of the plurality of slits 432.

The partition wall 460 is provided on the air supply chamber 450 side of the side wall portion 430. The partition wall 460 has a shape bent toward the side opposite to the blower fan 440A or the blower fan 440B. For example, the partition wall 460 is bent toward the front side. Accordingly, the air supplied to the air supply chamber 450A through the slit 432 also moves to the front side along the partition wall 460. This allows cool air to reach a wider area, and makes the blower fan 440A less visible from the outside of the operation housing 400.

As illustrated in FIG. 4, in the present embodiment, the microwave grill device 100 includes a wiring portion 501. A cable CA extending from the operation unit 40 is wired to the wiring portion 501. For example, the wiring portion 501 is a terminal block. The wiring portion 501 is disposed on a side opposite to the operation unit 40 with respect to the first heating unit 20. Specifically, the wiring portion 501 is attached to the rear side of the rear wall 35 of the grill chamber 39. In addition, a wiring hole 342 through which the cable CA extending from the operation unit 40 passes is provided on the rear surface of the operation housing 400. The cable CA passing through the wiring hole 342 passes, for example, below the grill chamber 39 and is wired to the wiring portion 501.

In this manner, by providing the wiring portion 501 outside the operation unit 40, it is easy to secure an air passage inside the operation housing 400.

Hereinbefore, the embodiments of the present disclosure have been described above with reference to the drawings. However, the present disclosure is not limited to the above embodiments, and can be implemented in various aspects without departing from the gist thereof. In addition, a plurality of constituent elements disclosed in the above embodiment can be appropriately modified. For example, one constituent element of all constituent elements shown in one embodiment may be added to a constituent element of another embodiment, or some constituent elements of all constituent elements shown in one embodiment may be deleted from the embodiment.

In order to facilitate understanding of the disclosure, the drawings schematically illustrate each constituent element mainly, and the thickness, length, number, interval, and the like of each illustrated constituent element may be different from actual ones for convenience of drawing creation. In addition, the configuration of each constituent element shown in the above embodiments is merely an example and is not particularly limited, and it goes without saying that various modifications can be made without substantially departing from the effects of the present disclosure.

The present disclosure is applicable to the field of heating cookers.

What is claimed is:

1. A heating cooker comprising:
a first heating unit on which a first object to be heated is placed, the first heating unit being configured to heat the first object to be heated;
a support unit configured to support a lower side of the first heating unit; and
an operation unit which receives operation information on the first heating unit,
wherein the operation unit is provided on one side in a first direction intersecting an up-down direction,
the support unit includes
a placement portion on which the first heating unit is placed, and
a column portion which extends downward from the placement portion, and
the placement portion is provided so as to extend over an entire width of the first heating unit along a second direction intersecting the up-down direction and the first direction.

2. The heating cooker according to claim 1, wherein
the first heating unit includes a first heating device and a second heating device disposed side by side in the first direction, and
the placement portion includes
a first placement portion which extends below the first heating device in the second direction, and
a second placement portion which extends below the second heating device in the second direction.

3. The heating cooker according to claim 2, wherein
the first heating device and the second heating device have an annular shape,
the first placement portion is provided on one side in the first direction with respect to a center of the first heating device, and
the second placement portion is provided over one side and another side in the first direction including a center of the second heating device.

4. The heating cooker according to claim 2, further comprising:
a heating chamber which is positioned below the first heating unit and houses a second object to be heated; and
a second heating unit configured to heat the second object to be heated,
wherein the column portion includes
a pair of first column portions extending downward from the first placement portion, and
a pair of second column portions extending downward from the second placement portion,
one of the pair of first column portions and one of the pair of second column portions are connected to an end of the heating chamber on one side in the second direction, and
another of the pair of first column portions and another of the pair of second column portions are connected to an end of the heating chamber on another side in the second direction.

5. The heating cooker according to claim 4, wherein
the first placement portion and the second placement portion have a same shape, and
each of the pair of first column portions and each of the pair of second column portions have a same shape.
